(19) United States
(12) Patent Application Publication
(10) Pub. No.: US 2020/0058087 A1
(43) Pub. Date: Feb. 20, 2020

(54) Method for Using Health Care Claims Data to Deduce the Terms of Contracts for Payment Between Health Plan Administrators and Health Care Providers

(71) Applicant: Chapin Del Sol White, Takoma Park, MD (US)

(72) Inventor: Chapin Del Sol White, Takoma Park, MD (US)

(21) Appl. No.: 16/537,532

(22) Filed: Aug. 10, 2019

Related U.S. Application Data
(60) Provisional application No. 62/719,905, filed on Aug. 20, 2018.

(51) Int. Cl. G06Q 50/18; G06Q 20/22

(52) U.S. Cl. CPC G06Q 50/18; G06Q 20/22

(57) ABSTRACT

The present invention provides a computer-method for using statistical analysis to deduce the details of an unknown deterministic branching data generating process (DGP) which, in the preferred embodiment, is the claims processing algorithm used by a health plan administrator. The computer-method, in the preferred embodiment, includes accessing data on paid health care claims; splitting the claims data into subsets with a separate subset for each combination of health plan administrator, broad type of service (e.g. inpatient hospital care), and health care provider; defining possible contract types; identifying links among claims that reveal possible specific contracts; identifying a best specific contract for each claim; and running a partitioning tree model using the best specific contract for each claim as a categorical outcome to be predicted and including as predictors the date of service, the type of service, and other characteristics of the service.

### REFERENCE TO RELATED APPLICATIONS

This application claims an invention which was disclosed in Provisional Application No. 62/719,905, filed Aug. 20, 2018, entitled “Method for Using Health Care Claims Data to Deduce the Terms of Contracts for Payment Between Health Plan Administrators and Health Care Providers.” The benefit under 35 USC § 119(e) of the United States provisional application is hereby claimed, and the aforementioned application is hereby incorporated herein by reference.

### ACKNOWLEDGMENT OF GOVERNMENT SUPPORT

Not applicable

### FIELD OF THE INVENTION

The invention pertains to the field of data science and the use of statistical analysis to deduce the details of a deterministic branching data generating process, with an application to analysis of payments for health care services. More particularly, the invention pertains to using data on paid health care claims to deduce the specific terms of contracts for payment between health plan administrators and health care providers, which can provide valuable insights for sponsors of health plans into the nature and quality of those contracts.

### BACKGROUND OF THE INVENTION

At a high level, payments for health care for an insured patient in the U.S. typically involve four entities:
a plan sponsor, whose role is to oversee the patient's health plan, including collecting financial resources and providing those resources to the plan administrator;
a plan administrator, whose role is to enter into contracts with networks of health care providers and pay providers according to the benefits of the health plan and the terms of those provider contracts;
health care providers, whose role is to provide health care services to plan enrollees in exchange for payments from the plan administrator and from enrollees; and
patients, who enroll in the health plan, who receive health care services and who may provide financing through premium contributions paid to the plan sponsor or out-of-pocket payments to health care providers.

For most individuals enrolled in private health insurance in the U.S., the plan sponsor is an employer, and the plan administrator is a commercial entity (typically referred to as a “health insurer”) selected by the employer. According to the Kaiser Family Foundation's 2017 Employer Health Benefits Survey, among workers covered by employer-sponsored health plans 60 percent are in “self-funded” health plans. Under a self-funded arrangement, the employer bears the financial risk of incurred health care costs while a “third party administrator” (TPA) processes “claims” where claims are requests for payment for services rendered. The remaining 40 percent of workers are in “fully insured” health plans, meaning that the employer pays a health insurer a fixed premium and the health insurer bears financial risk and acts as administrator of the plan.

The contracts between plan administrators and health care providers are key drivers of the costs of the health care plan. The specific terms of those contracts specify formulas or methodologies that determine the “allowed amount” for each service, meaning the payments that providers are entitled to receive in exchange for the services they provide. A growing body of research highlights the wide variation—from one geographic market to another, and from one provider to another—in the contracted allowed amounts for equivalent services. As Paul Ginsburg pointed out in his 2010 Research Brief (“Wide Variation in Hospital and Physician Payment Rates Evidence of Provider Market Power”), that variation in allowed amounts suggests that consolidation among providers has allowed some providers to demand and receive contracted payment rates significantly higher than would occur in a competitive market.¹

Employers offering self-funded health plans bear direct financial responsibility for their employees' covered health care costs, and have a compelling and have a legitimate interest in investigating and assessing the contracts between their TPAs and health care providers. But, the standard industry practice is for plan administrators to block self-funded employers from inspecting or analyzing the terms of the contracts between the plan administrators and health care providers. TPAs in some cases claim that those contracts, and the payment terms specified therein, are trade secrets that cannot be shared with the employer sponsors of the plan. The lack of competitiveness in health care markets can be explained, at least in part, by employers' ignorance regarding the contracts entered into on their behalf.

A high-quality set of contracts between health plan administrators and health care providers would specify payment levels that reflect the costs of an efficient high-quality provider, and those payment levels would grow at a sustainable rate. A low-quality set of contracts would allow payments to vary arbitrarily (e.g. based on a hospital's billed charges), and grow unsustainably over time. A set of contracts would also be of low quality if providers received excessive financial rewards for providing services of unclear clinical benefit.

One approach that has been used to investigate contract provisions is simply to ask health plan administrators how, and how much, they pay providers. Paul Ginsburg, in his 2010 Research Brief, took that approach and reported the share of payments for inpatient hospital care in three broad contract types: per diem (i.e. the allowed amount equals the length of the inpatient stay in days multiplied by a daily rate), discounted charges (i.e. the allowed amount equals the hospital's billed charges multiplied by a discount rate), and case rates (i.e. the allowed amount equals a base rate per stay multiplied by a casemix adjustor). Asking health plan administrators about their contract arrangements has major limitations: it relies on the goodwill and cooperation of the health plan administrator, and it can only give a very broad-brush indication of the terms of the contracts.

Another approach that has been used to investigate contract provisions is to use statistical analyses. These analyses typically group claims data into very narrow subsets of services (e.g. a specific type of procedure within a single hospital) and, within each of those subsets look for repeated occurrences of specific payment “signatures.” Those payment signatures could consist of repeated values of the actual payment amount, or repeated discount rates, or repeated per diems. That approach has at least three major limitations:
First, contract types will be difficult or impossible to determine for provider-service type combinations with low or no volume—if there is only one service within a narrow subset of services it is impossible to detect repeated payment signatures within that narrow subset.
Second, searching for simple one-dimensional payment signatures cannot detect complex payment provisions. For example, some provider contracts specify that special outlier provisions will apply for individual patients' services that are unusually costly. Another example of a complex provision is a blend of multiple bases of payment, such as per diem plus discounted charges, or differential discount rates applied to different cost categories.
Third, the analyst faces a difficult choice between selecting and focusing only on a manageable set of common services (which will end up ignoring many of the services in the claims data), or testing for contract types for all specific types of services (which results in a vast and possibly overwhelming array of contract types, many of which are likely to be unpopulated and unclassifiable).

The current invention overcomes all three of those limitations.

### SUMMARY OF THE INVENTION

The invention comprises a computer-method for using statistical analysis to deduce the details of an unknown deterministic branching data generating process (DGP). In the preferred embodiment, the DGP is the claims processing algorithm used by a health plan administrator. That claims processing algorithm embeds the terms of the contracts for payment between the health plan administrator and health care providers. In the preferred embodiment, data on paid health care claims are used to deduce the specific terms of contracts for payment between health plan administrators and health care providers. That DGP cannot be directly observed or inspected by the analyst, and so, prior to application of the computer-method, is unknown to the analyst. The DGP is deterministic, meaning, in the preferred embodiment, that the health plan administrator is applying fixed payment rules, without the random noise or errors typically assumed to exist in conventional statistical analyses. That DGP is a branching algorithm, meaning, in the preferred embodiment, that the claims are routed in a branching manner to different payment rules depending on identity of the provider, the date of the service, and other factors some or all of which are unknown to the analyst.

The computer-method, in the preferred embodiment, includes accessing data on paid health care claims; splitting the claims data into subsets with a separate subset for each combination of health plan administrator, broad type of service (e.g. inpatient hospital care), and health care provider; defining possible contract types; identifying links among claims that reveal possible specific contracts; identifying a best specific contract for each claim; and running a partitioning tree model using the best specific contract for each claim as a categorical outcome to be predicted and including as predictors the date of service, the type of service, and other characteristics of the service.

One key advantage of the embodiments described herein is that they allow the user to specify at a very high level a broad set of possible contract types suspected of existing, including simple one-dimensional contract types and more-complex contract types. The results of the method are specific contracts (e.g. a per diem of $2000, a per diem of $2500, a discount of 76.5%, and a discount of 82.5%), and branching rules relating to which contract type is applied to which claim. The method also highlights for the user types of claims for which an unknown contract type is in place and for which additional outside information would be useful.

### BRIEF DESCRIPTION OF THE FIGS

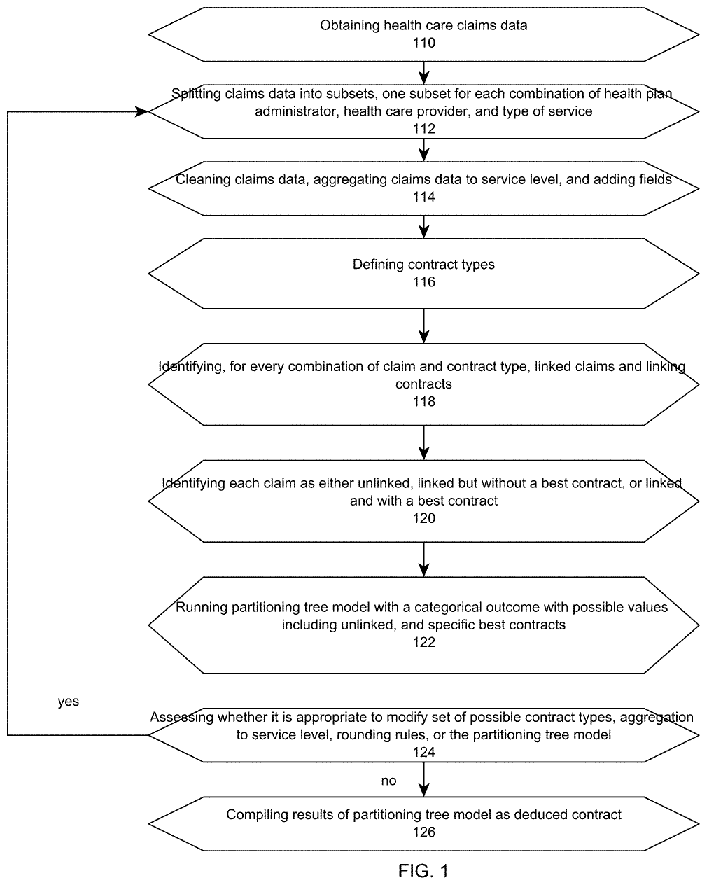

FIG. 1 shows a flow chart that includes the general steps taken to use data on paid health care claims to deduce the specific terms of contracts for payment between health plan administrators and health care providers.

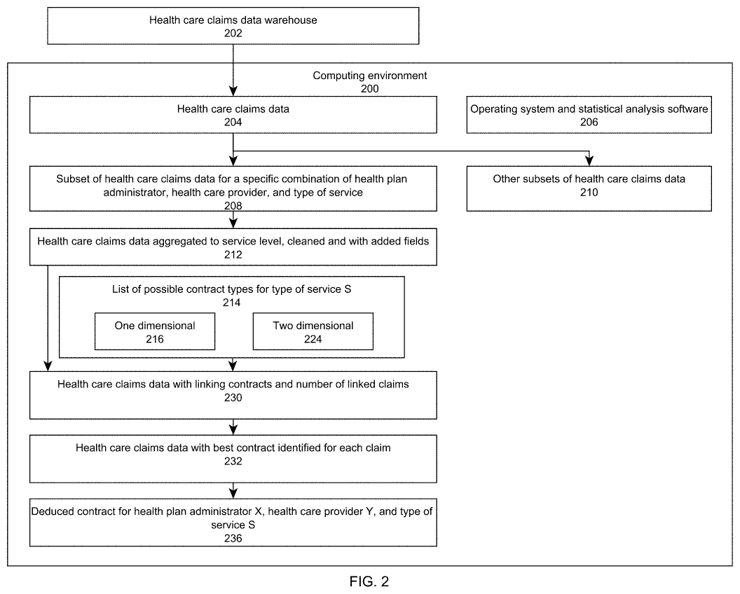

FIG. 2 shows a block diagram of a system that the method of FIG. 1 is operable.

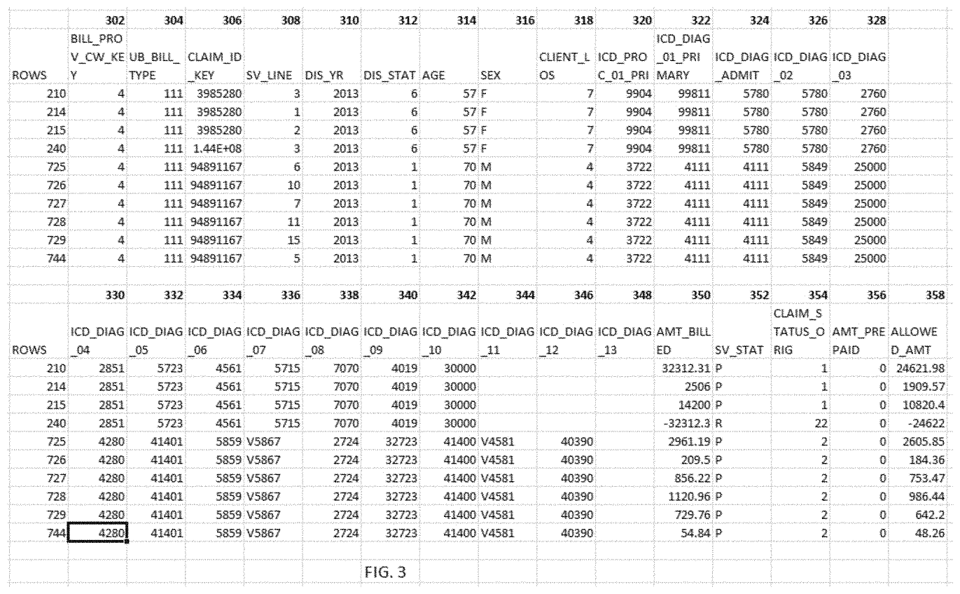

FIG. 3 is a table illustrating exemplary fields for a subset of health care claims data.

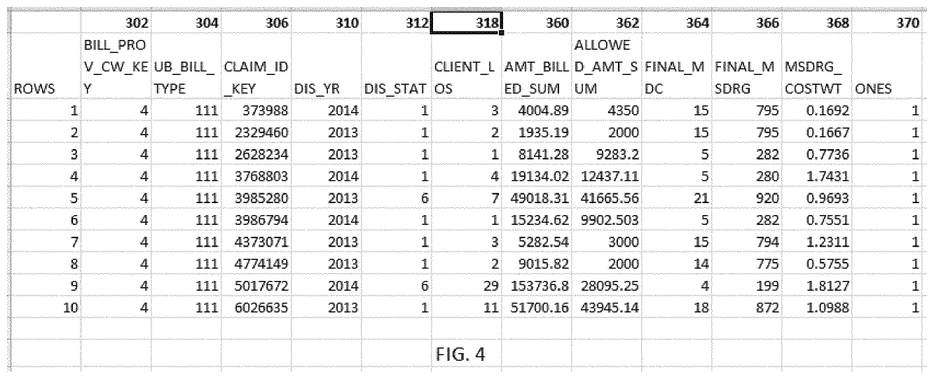

FIG. 4 is a table illustrating exemplary fields for a subset of health care claims data that have been cleaned and aggregated and with additional fields added.

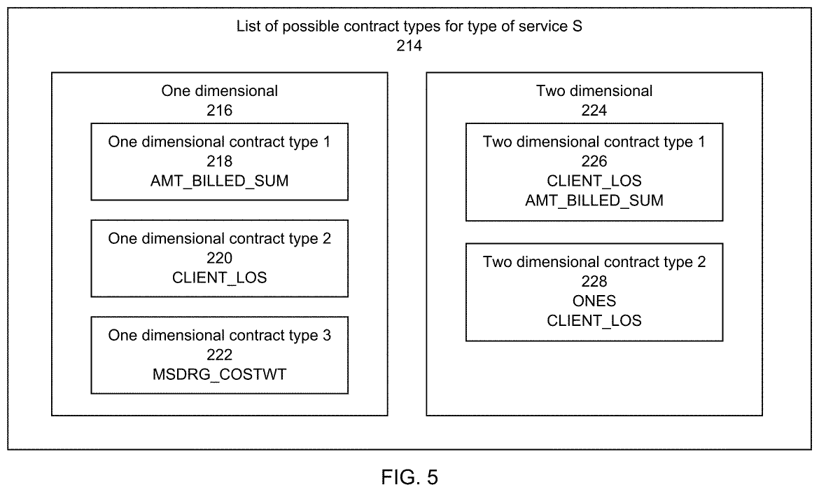

FIG. 5 is a table illustrating exemplary fields corresponding to one- and two-dimensional contract types.

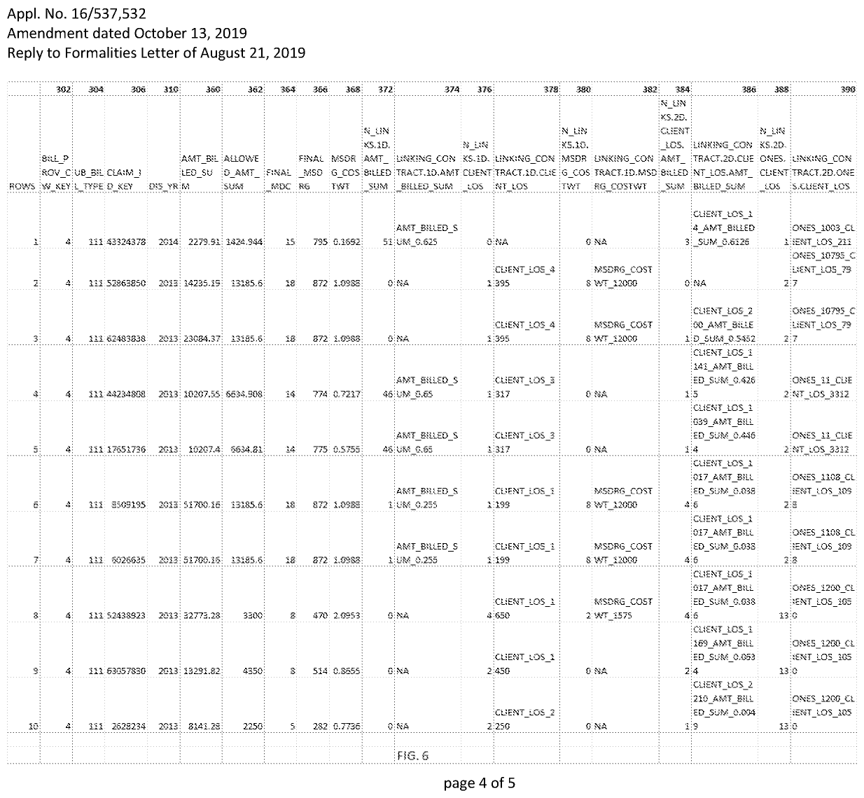

FIG. 6 is a table illustrating exemplary fields corresponding to the number of linked claims and linking contracts.

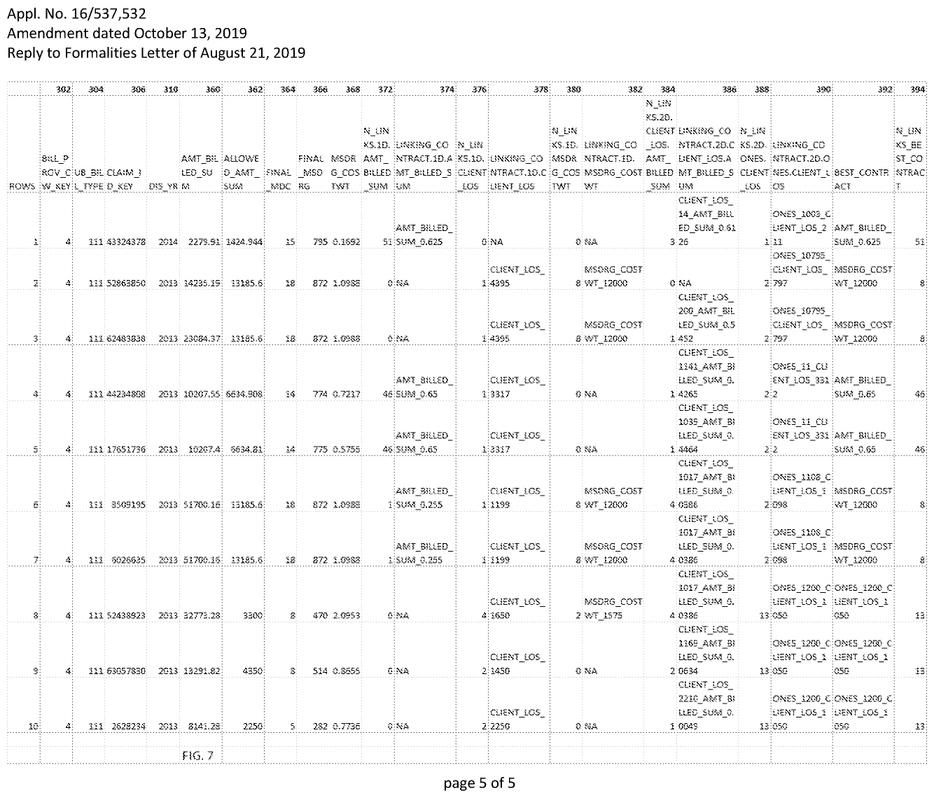

FIG. 7 is a table illustrating exemplary fields including a categorical field representing the best contract.

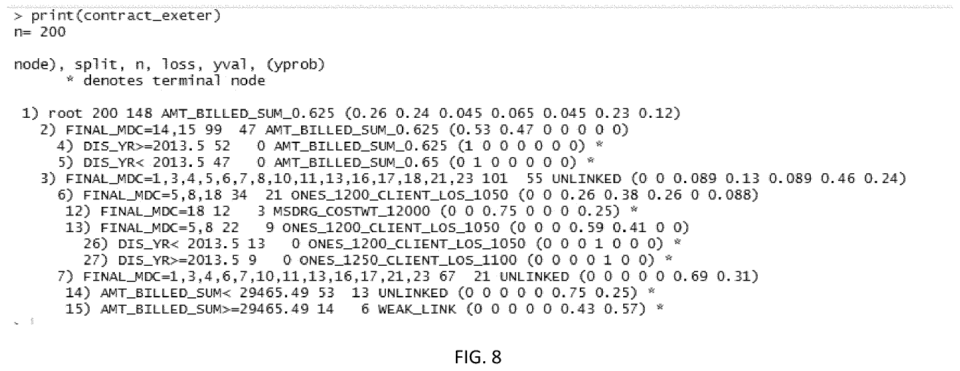

FIG. 8 illustrates exemplary output of a partitioning tree model.

### DETAILED DESCRIPTION OF THE INVENTION

As illustrated in FIG. 1, the process begins with obtaining health care claims data 110. In one embodiment of this step, a self-funded employer would request and receive a copy of the claims data for their enrollees from their TPA. In another embodiment of this step, a researcher would receive a copy of claims data from a state-run all payer claims database (APCD). In other embodiments, a self-funded employer would request that their claims data be transferred from their TPA to a third-party analyst.

As shown in the block diagram in FIG. 2, in one embodiment step 110 involves the transfer of claims data from a claims data warehouse 202 to the analyst's computing environment 200. In the exemplary embodiment used to illustrate the invention, the claims data warehouse 202 is the New Hampshire All Payer Claims Database (APCD).

The analyst's computing environment 200 is used to store the claims data to be used in the analysis 204 as well as an operating system and statistical analysis software 206. The operating systems in various embodiments could include a personal computer (PC) operating the Windows operating system, a networked Unix server, a cloud-based data storage system, or another platform. The statistical analysis software in various embodiments could include various combinations of SAS, R, Stata, Python, casemix groupers, and other software capable of processing data and performing statistical analysis and reporting. It is to be understood that the operating system and various statistical analysis software packages are used in various combinations for the steps of the process illustrated in FIG. 1.

The next step in the process, as illustrated in FIG. 1, is splitting claims data into subsets 112, with one subset for each combination of health plan administrator, health care provider, and type of service. It is to be understood that “health plan administrators” in this step correspond to the entities paying health care providers based on contracts with those providers, and “health care providers” correspond to the entities entering into contracts with health plan administrators to provide health care services in exchange for payment from those administrators. Examples of health care providers could include an individual physician, a physician practice, a rehabilitation clinic, an ambulatory surgical center, a single hospital, a large multi-facility hospital system, or some other type of provider entity. When analyzing claims where the Medicare fee-for-service program is the health plan administrator, the health care provider would likely best be defined and identified by the Medicare provider number. In contrast, when analyzing data on claims paid by a commercial health plan, the best identifier for the health care provider could be the tax identification number of the billing provider.

It is to be understood that “type of service” refers to a broad category of health care services. For example, in the exemplary embodiment described below “hospital inpatient care” represents the exemplary type of service. In that exemplary embodiment, services included the hospital inpatient care type of service would be identified as those billed using the CMS-1450 (“institutional”) claim form where the “type of bill” field equals 111. Other examples of types of services include “physician office-based visits,” which would be identified as those billed using the CMS-1500 (“professional”) claim form where the “place of service” field equals 11. The boundaries and definitions of “health plan administrator,” “health care provider,” and “type of service” should align, to the degree possible, with the contracting entities and claims processing arrangements that generated the claims data being analyzed 204. It is to be understood that part of the process that comprises the current invention includes formulating and testing alternative boundaries and definitions of “health plan administrator,” “health care provider,” and “type of service.”

The analyst may find it useful, when splitting claims data into subsets in step 112, to set aside a validation sample that will be used later, in step 124, to test the performance of the predictive model. The analyst may also choose to create multiple training and validation subsamples in this step, so that the performance of the model can be measured using bootstrapping techniques.

As shown in FIG. 2, after being split into subsets, the claims data would include at least one subset of claims data to be analyzed 208. It is to be understood that this step will produce other subsets of claims data 210 that may also be analyzed separately.

FIG. 3 illustrates the types of fields contained in the subset of claims data 208 in an exemplary embodiment. The illustration represents claims data for inpatient hospital stays provided by a single facility. Accordingly, the subset only contains claims data for a single billing provider identifier (BILL_PROV_CW_KEY=4, which, in the New Hampshire APCD, corresponds to Exeter Hospital in Exeter, N.H.) 302, and only includes medical claims for a single bill type (UB_BILL_TYPE=111, which corresponds to inpatient hospital care) 304. In the exemplary illustration, each inpatient hospital stay is indicated by CLAIM_ID_KEY 306 and each row of data represents a line item, which are indexed by SV_LINE 308. In this illustration, the fields include the year of discharge (DIS_YR) 310, discharge status (DIS_STAT) 312, patient age (AGE) 314, patient sex (SEX) 316, length of the inpatient hospital stay in days (CLIENT_LOS) 318, primary procedure (ICD_PROC_01_PRI) 320, and diagnosis codes (ICD_DIAG_01_PRIMARY, ICD_DIAG_ADMIT, and ICD_DIAG_02 through ICD_DIAG_13) 322 through 348, billed charges for each line item (AMT_BILLED) 350, and indicators for denied or reversed line items (SV_STAT, P=paid, D=denied, R=reversed) 352, claim status (CLAIM_STATUS_ORIG, 1=Processed as primary, 2=Processed as secondary, 3=Processed as tertiary, 4=Denied, 22=Reversal) 354, and amounts paid under capitation arrangements (AMT_PREPAID) 356. It is to be understood that, in other embodiments, the fields and codes contained in the subset of claims data would differ from this example.

The next step in the process, as illustrated in FIG. 1, is cleaning the claims data, aggregating the claims data to the service level if necessary, and adding fields 114. Cleaning the claims data could, in one embodiment, comprise removing claims that have any line items reversed or denied, or removing claims for which the allowed amount equals zero, or removing claims with missing values for key fields such as primary diagnosis. Cleaning the claims data could also include removing any claims for which the health plan administrator of interest was not the primary payer. The goal in cleaning and aggregating the claims data is for the claims data, after this step is performed, to represent as precisely as possible the process and output of the health plan administrator's claims processing system

For some types of service, such as hospital inpatient care, a single inpatient hospital stay typically appears in the claims data as multiple rows, each representing a line item. In that type of situation, it may be appropriate to aggregate all the line items for each stay to create a stay-level claim that includes total billed charges for the stay and the total allowed amount for the stay.

The fields to be added in step 114 could, in one embodiment, include ones (i.e. a field that that equals one for each claim), or Medicare casemix groups or casemix weights (e.g. Medicare Severity Diagnosis Related Groups, or MS-DRGs, for hospital inpatient claims), or the sum of billed charges for line items meeting certain criteria (e.g. billed charges for all line items with a revenue code “0278” which indicates an implantable device). The goal in adding fields is to have the claims data include all, or as many as possible, of the claim attributes and numeric values that are used the health plan administrator's claims processing algorithm.

The result of the cleaning, aggregating, and adding fields, as illustrated in FIG. 2, is a cleaned and aggregated set of claims data with additional fields added 212. FIG. 4 illustrates the types of fields contained in the aggregated and cleaned subset of claims data 212 in an exemplary embodiment. In this illustration, the subset of inpatient hospital claims data 208 has been aggregated to the stay level (CLAIM_ID_KEY) 306, billed charges have been summed to the claim level (AMT_BILLED_SUM) 360, allowed amounts have been summed to the claim level (ALLOWED_AMT_SUM) 362, and stays with any line items denied or reversed have been removed. Also, some claims are included in the subset of claims data 208 that paid by a secondary primary payer such as a supplemental insurer providing wraparound coverage for a Medicare beneficiary—any claims not processed as by the primary payer were excluded in this exemplary illustration. In this illustration, the exemplary stay-level claims data have been run through Medicare's inpatient hospital grouper and casemix adjustment software, and, based on the output of that grouper software, assigned a major diagnostic category (FINAL_MDC) 364, a categorical MS-DRG (FINAL_MSDRG) 366, and a Medicare casemix weight (MSDRG_COSTWT) 368. Each stay is also assigned a field equal to one for all claims (ONES) 370. The Medicare casemix variables and the ones are added at this step because they may be useful for deducing the presence of certain contract types. It is to be understood that cleaning and processing claims data could involve many other possible exclusion rules, include the creation of many other aggregate fields, and for different type of services would involve other casemix weights and groupers.

The next step in the process, as shown in FIG. 1, is defining a set of possible contract types 116. At this point, it may be helpful to preview and clarify the terminology relating to contract types and specific contracts:

A “contract type” is defined as a set of one or more fields in the claims data that, for claims paid under that contract type, jointly determine the allowed amount for each claim. For claims paid under a given contract type, the allowed amounts will equal the sum of the products of the fields that constitute that contract type multiplied by nonzero fixed parameters (“fixed” meaning they are constant within a specific contract between a health plan administrator and health care provider). The dimension of a contract type corresponds to the number of fields that constitute the contract type. An example of a one-dimensional contract type is simple discounted charges, and that contract type consists of a single field: billed charges. For claims that are paid under a simple discounted charge contract type, the allowed amount equals billed charges multiplied by a nonzero fixed parameter (the “discount rate”). As part of the process that comprises the present invention, the analyst will hypothesize the existence of one or more contract types, and part of the process that comprises the current invention includes expanding or contracting the set of contract types.

A “candidate contract” is defined for each combination of N claims and contract type, where N is the dimension of the contract type. A candidate contract consists of a specific set of N nonzero fixed parameters that are consistent with the allowed amounts and with the observed values of the fields that comprise the contract type. Candidate contracts are identified in the claims data using the allowed amount and the fields that comprise the contract type, as described in more detail below. Continuing with the example above, if the contract type is simple discounted charges, and a given claim has an allowed amount of $750.00 and billed charges of $1000.00, then the candidate contract is simple discounted charges with a discount rate of 0.75. The same claim will have other candidate contracts for other one-dimensional contract types, and will be used to form other candidate contracts with other two- or higher-dimensional contract types. Candidate contracts are referred to as “candidates” because they are generated by default for all combinations of contract types and N claims, and they do not by themselves reveal the existence of specific contracts that generated the observed allowed amounts.

A “linked claim” is a claim where the actual allowed amount is approximately equal to the allowed amount predicted based on a candidate contract where the candidate contract is generated based on a set of N claims that do not include the linked claim itself.

A “linking contract” is a candidate contract (if any) with one or more linked claims. A linking contract may be identified for each combination of claim and contract type. Continuing with the example above, for the simple discounted charge contract type with a discount rate of 0.75, that candidate contract would be considered a linking contract of if 1 or more claims (other than the claim used to generate the candidate contract) exist in the claims data where the allowed amount is approximately equal to billed charges multiplied by 0.75. For a contract type of dimension N, a linking contract consists of N coefficients where the N coefficients are specific nonzero numeric values that produce allowed amounts approximately equal to actual allowed amounts for all of the claims linked by the linking contract.

A “best contract” is defined for each claim as the linking contract (possibly null) that links to the largest number of other claims in the claims data. Continuing with the example above, suppose the analyst has specified two contract types: simple discounted charges, and simple per diem. If a given claim links to 20 other claims through the simple discounted charge contract type with a discount rate of 0.75, and the same claim links to only one other claim through the simple per diem with a per diem of $1000, then the best contract for that claim is simple discounted charges with a discount rate of 0.75.

As shown in FIG. 2, contract types 214 may have one dimension 216, two dimensions 224, or three or more dimensions (not shown). In general, a one-dimensional contract type consists of a single field, a two-dimensional contract type consists of two fields, a three-dimensional contract type consists of three fields, and so on. It is to be understood that the present invention includes contract types that may have three or more dimensions, although those three-or-more dimensional contract types are not illustrated in the figures or the exemplary embodiment.

The general formula for claims paid under a one-dimensional contract type is:

ALLOWED_AMTᵢ=a_{c}Xᵢ+eᵢ [1]

where
ALLOWED_AMTᵢ is the allowed amount for claim i,
X is a field that corresponds to a one-dimensional contract type,
Xᵢ is the specific value of X for claim i,
a_{c} is a non-zero fixed parameter that corresponds to a specific one-dimensional contract c, and
eᵢ is an error term.

Equation [1] reflects a deterministic process, meaning that the health plan administrator is processing claims and applying payment rules that determine payment amounts presumably without adding random variation. Despite the determinicity of that data generating process, an error term eᵢ is still included in equation [1]. That error term is included to reflect the fact that allowed amounts in claims data will inevitably be rounded, either to the nearest penny or the nearest dollar or based on some other rounding rule. Suppose, for example, the billed charges for a service are $1575.00 and the contract specifies that allowed amounts are based on a discounted charge contract with the discount rate equal to 0.749. Then, if allowed amounts are rounded to the nearest penny, the allowed amount that appears in the claims data will be $1179.68 (i.e. $1575.00 multiplied by 0.749) and the error for that claim, will be 0.005 (half a cent). If allowed amounts in the claims data are rounded to the nearest dollar, then the allowed amount that appears in the claims data will be $1180.00 and the error for that claim, eᵢ, will be 0.325 (thirty two and a half cents).

The general formula for claims paid under a two-dimensional contract type is:

ALLOWED_AMTᵢ=a_{c}Xᵢ+b_{c}Yᵢ+eᵢ [2]

where
ALLOWED_AMTᵢ, X, Xᵢ, and eᵢ are as defined above,
X and Y are fields that jointly correspond to a two-dimensional contract type,
Yᵢ is the specific value of Y for claim i, and
a_{c} and bₑ are non-zero fixed parameters that jointly correspond to a specific two-dimensional contract c.

The general formula for claims paid under a three-dimensional contract type is:

ALLOWED_AMTᵢ=a_{c}Xᵢ+b_{c}Yᵢ+d_{c}Zᵢ+eᵢ [3]

and so on.

FIG. 5 illustrates an exemplary set of fields corresponding to a set of one-dimensional contract types 216 and a set of two-dimensional contract types 224 in an embodiment. The first exemplary one-dimensional contract type is AMT_BILLED_SUM (the claim-level sum of billed charges) 218, which represents a simple discounted charge contract type (“simple” referring to that fact that this one-dimensional contract type includes no outlier provisions or blending of discounted charges plus another basis of payment). The second exemplary one-dimensional contract type is CLIENT_LOS (the length of the inpatient stay in days) 218, which represents a simple per diem contract type. The third exemplary one-dimensional contract type is MSDRG_COSTWT (the casemix weight assigned to the claim using Medicare's inpatient hospital grouper and cost weights) 220, which represents a simple multiple-of-Medicare case rate.

The first exemplary two-dimensional contract type is CLIENT_LOS and AMT_BILLED_SUM 226, which represents a blended contract type consisting of a per diem plus discounted charges. The second exemplary two-dimensional contract type is ONES and CLIENT_LOS 228, which represents an intercept plus per diem contract type.

As shown in FIG. 2, the next step in the process is identifying, for every combination of claim and contract type, a set of linked claims (possibly null) and, if a set of linked claims exists, a linking contract 118. In step 118, if the analyst has specified one or more contract types with two or more dimensions, then the step of identifying linked claims and linking contracts will include those multi-dimensional contract types.

The present invention comprises three alternative embodiments for step 118 denoted Alternatives 1, 2, and 3.

Alternative 1. Generate a Candidate Contract for Each N Claims and Test for Linked Claims

This alternative will first be illustrated using the exemplary one-dimensional contract type AMT_BILLED_SUM, which corresponds to a simple discounted charge contract. For each claim, a candidate contract of the simple discounted charge contract type is identified using the following formula:

a_{c}(i)=ALLOWED_AMTᵢ/AMT_BILLED_SUMᵢ [4]

where a_{c}(i) is the discount rate for claim i. This is referred to as a “candidate contract” because it has not yet been tested for the existence of links with other claims. In this illustration, a_{c}(i) may be calculated applying a rounding rule, such as rounding to the nearest thousandth (i.e. 0.001). Claims i and j are then determined to be linked for this candidate contract if the following formula holds:

ALLOWED_AMTᵢ≅a_{c}(i)AMT_BILLED_SUMⱼ [5]

For example, claims i and j are linked for the simple discounted charge contract type if the discount rate calculated from claim i correctly predicts (within allowable bounds) the allowed amount for claim j. If the two claims are found to linked, the linking contract that links them is the discount rate from claim i (which, by definition, is approximately equal to the discount rate from claim j). It is to be understood that determining whether two or more claims are linked will involve rounding and bounds. In one embodiment of the current invention, the allowable bounds for the determination of approximately equal in the example in equation [5] can use a range equal to Xⱼ multiplied by plus or minus half of the rounding unit (0.001 in the example).

The process for the identification of linked claims is repeated for each one-dimensional contract type.

As illustrated in FIG. 5, an example of a multi-dimensional contract type is the blended per diem plus discounted charges 226, which corresponds to the following fields: CLIENT_LOS and AMT_BILLED_SUM.

In general, if a contract type has N dimensions, then the number of claims used to identify a candidate contract is also N, and the minimum number of claims needed to identify a linking contract is N+1 (i.e., the N claims used to identify the candidate contract plus at least one other claim that links to that candidate contracts). For example, for two-dimensional contract types, if the analyst takes any pair of claims i and j and assumes the error terms (eᵢ and eⱼ) are zero, then values of a_{c}(i,j) and b_{c}(i,j) can be calculated that are consistent with those claims. One exemplary set of formulas that identify a_{c}(i,j) and b_{c}(i,j) is as follows:

b_{c}(i,j)=(XᵢALLOWED_AMTⱼ−XⱼALLOWED_AMTᵢ)/(XᵢYⱼ−XⱼYᵢ) [7]

a_{c}(i,j)=(ALLOWED_AMTᵢ−b_{c}(i,j)Yᵢ)/Xᵢ [8]

The analyst can identify a two-dimensional linking contract consisting of a_{c}(i,j) and b_{c}(i,j) if, for a trio of claims (i, j, and k), the following holds true:

ALLOWED_AMTₖ≅a_{c}(i,j)Xₖ+b_{c}(i,j)Yₖ [9]

If we take the general formulas [7] and [8] and customize it to our exemplary two-dimensional contract type 226, we have this formula for b_{c}(i,j):

$${b}_{c} ( i , j ) = ( {CLIENT\_LOS}_{i} {ALLOWED\_AMT}_{j} - {CLIENT\_LOS}_{j} {ALLOWED\_AMT}_{i} ) \\ / \\ ( {CLIENT\_LOS}_{i} AMT\_BILLED {\_SUM}_{j} - {CLIENT\_LOS}_{j} AMT\_BILLED {\_SUM}_{i} ) \qquad [ 10 ]$$

and we have this formula for a_{c}(i,j):

$${a}_{c} ( i , j ) = ( {ALLOWED\_AMT}_{i} - {b}_{c} ( i , j ) AMT\_BILLED {\_SUM}_{i} ) \\ / \\ {CLIENT\_LOS}_{i} \qquad [ 11 ]$$

Using formulas [9], [10], and [11], for every trio of claims we can determine whether they are linked and, if so, the linking contract. It is to be understood that testing whether equation [9] holds for each trio will involve rounding and testing for approximate equality and that part of the process described in the current invention involves testing and modifying various rounding rules and bounds.

It is to be understood that the current invention includes three- or more dimensional contract types, and that testing for linking contracts for those contract types involves a straightforward extension of the principles illustrated in equations [7] through [11].

Alternative 2. Test Directly for Linking Contracts Using N+1 Claims, and Identify the Linking Contract Only if One is Found to Exist

In Alternative 2, the analyst uses a series of matrix operations to directly identify whether a linking contract exists and, if one does, the specific linking contract. For example, suppose the contract type is three dimensional and consists of ONES (denoted X₁), MSDRG_COSTWT (denoted X₂), and AMT_BILLED_SUM (denoted X₃). For every possible combination of four claims (i, j, k, and l), the analyst can define a 4×3 matrix of X's:

$$X = [ \begin{matrix}{X}_{1 , i} & {X}_{2 , i} & {X}_{3 , i} \\ {X}_{1 , j} & {X}_{2 , j} & {X}_{3 , j} \\ {X}_{1 , k} & {X}_{2 , k} & {X}_{3 , k} \\ {X}_{1 , l} & {X}_{2 , l} & {X}_{3 , l}\end{matrix} ] \qquad [ 12 ]$$

a 4×1 vector of allowed amounts (Y's):

$$Y = [ \begin{matrix}{Y}_{i} \\ {Y}_{j} \\ {Y}_{k} \\ {Y}_{l}\end{matrix} ] \qquad [ 13 ]$$

and a 4×4 matrix, Z, that concatenates X and Y:

$$Z = [ \begin{matrix}X & Y\end{matrix} ] = [ \begin{matrix}{X}_{1 , i} & {X}_{2 , i} & {X}_{3 , i} & {Y}_{i} \\ {X}_{1 , j} & {X}_{2 , j} & {X}_{3 , j} & {Y}_{j} \\ {X}_{1 , k} & {X}_{2 , k} & {X}_{3 , k} & {Y}_{k} \\ {X}_{1 , l} & {X}_{2 , l} & {X}_{3 , l} & {Y}_{l}\end{matrix} ] \qquad [ 14 ]$$

In Alternative 2, the analyst first tests for the linear independence, or non-singularity, of X′X, applying an appropriate tolerance value. (A square matrix is singular if the absolute value of the determinant of the matrix is less than the tolerance value. Examples of typical tolerances would be 1e-12 or 1e-16.) If X′X is singular, then the four claims that comprise X are not linearly independent and they cannot be used to identify a linking contract, and the analyst proceeds to test the next fourtuple of claims. If X′X is non-singular, then the analyst can test for singularity of Z′Z, again applying an appropriate tolerance. If X′X is non-singular but Z′Z is singular, then the four claims (i, j, k, and l) identify a linking contract. If the four claims identify a linking contract, then the analyst can define a vector of betas:

b=(X′X)⁻¹X′Y [15]

and those betas identify the fixed coefficients of the specific linking contract for that contract type and for those four claims (i, j, k, and l).

Alternative 3. Generate a Candidate Contract for Each Combination of N+1 Claims Using Matrix Operations, and Test Whether the Candidate Contract is a Linking Contract Using R-Squared

In Alternative 3, the analyst can use R-squared from linear regression operations to identify whether a linking contract exists. The illustration for Alternative 3 will follow the same example contract type used to describe Alternative 2.

As in Alternative 2, the analyst first tests for the singularity of X′X, applying an appropriate tolerance. If X′X is singular, then the four claims are not linearly independent and they cannot be used to identify a linking contract, and the analyst proceeds to test the next fourtuple of claims.

If X′X is nonsingular, the analyst calculates the following:

b=(X′X)⁻¹X′Y [16]

where b is an N×1 vector of estimated betas or coefficients;

Ŷ=Xb [17]

where Ŷ is an (N+1)×1 vector of predicted allowed amounts;

Y̅=(Yᵢ+Yⱼ+Yₖ+Yₗ)/4 [18]

where Y̅ is a 1×1 vector of mean allowed amount;

Y^{diff}=Y−Y̅ [19]

where Y^{diff} is an (N+1)×1 vector of differences between actual allowed amounts and the mean allowed amount;

ss=Y^{diff}′Y^{diff} [20]

where ss is a 1×1 vector of sum of squared differences;

e=Y−Ŷ [21]

where e is an (N+1)×1 vector of errors, or differences between actual allowed amounts and predicted allowed amounts;

sse=e′e [22]

where sse is the sum of squared errors (a 1×1 vector); and

$$rsq = 1 - \frac{sse}{ss} \qquad [ 23 ]$$

where rsq is R-squared (a 1×1 vector)

The analyst can then test whether the four claims identify a linking contract by testing whether rsq exceeds a threshold set by the analyst, such as 0.9999999. If rsq does exceed the threshold, then the vector b identifies the specific linking contract for that contract type and for those four claims (i, j, k, and l).

In each of the three Alternatives, it is to be understood that identification of linking contracts may include criteria applied to the fixed coefficients, such as constraining them to be strictly positive. Restricting linking contracts in this way helps reduce the number of false positive linking contracts, meaning candidate contracts with one or more linked claims but where the linking occurs by chance and not as a reflection of the health plan administrator's data generating process.

As illustrated in FIG. 2, the result of step 118 is a claims dataset 230 that includes for each combination of claim and contract type a linking contract (possibly null), and, if a linking contract exists, a count of the number of claims linked by that linking contract.

FIG. 6 illustrates an exemplary set of fields contained in claims dataset 230 that relate to the identification of linked claims for the exemplary contract types. In this example, for each claim i the number of linked claims is calculated for each one-dimensional contract type (N_LINKS.1D.AMT_BILLED_SUM 372, N_LINKS.1D.CLIENT_LOS 376, N_LINKS.1D.MSDRG_COSTWT 380) and for each two-dimensional contract type (N_LINKS.2D.CLIENT_LOS.AMT_BILLED_SUM 384, N_LINKS.2D.ONES.CLIENT_LOS 388). If a linking contract exists, then the specific linking contract is identified in the data (LINKING_CONTRACT.1D.AMT_BILLED_SUM 374, LINKING_CONTRACT.1D.CLIENT_LOS 378, LINKING_CONTRACT.1D.MSDRG_COSTWT 382, LINKING_CONTRACT.2D.CLIENT_LOS.AMT_BILLED_SUM 386, LINKING_CONTRACT.2D.ONES.CLIENT_LOS 390).

As illustrated in FIG. 1, the next step in the process 120 is to assign to each claim a value in a field that summarizes the results of the linking process 118. In the exemplary embodiment, a field, BEST_CONTRACT, is created and assigned a value, “UNLINKED,” to all claims that do not link to any other claims through any of the contract types. Each claim that links to one or more other claims is assigned a value to the BEST_CONTRACT field that corresponds to the best contract for that claim (i.e., the linking contract associated with the largest number of linked claims). The values assigned to the best contract field in this step may include a special value, such as “TIED,” if the claim has two or more linking contracts for which the number of linked claims is the same (or similar, applying bounds specified by the analyst) across those linking contracts. The values assigned to the best contract field in this step may also include a value, such as “WEAK_LINK,” if the claim has a linking contract but the number of linked claims is small. “Small” in this context should be defined by the analyst keeping in mind the fact that some false positive links will occur among claims, meaning that claims may share a linking contract even though they were not paid by the health plan administrator under the same contract provision. The probability that false-positive linking contracts will occur depends on several factors, including the rounding rules chosen by the analyst, the number of claims in the data, and the joint distributions and degree of bunching that occur in the data in allowed amounts and the fields included in the contract types. The analyst may, as part of step 120, choose to conduct a bootstrapping exercise to determine the distribution of the number of false-positive linked claims, and use that distribution to define “small.”

The result of step 120 is a dataset 232 with the best contract identified for each claim (including “UNLINKED”, “TIED” and “WEAK_LINK” as possible values for the best contract). FIG. 7 illustrates exemplary fields including a categorical field representing the best contract, BEST_CONTRACT 392, and a numerical field, N_LINKS BEST_CONTRACT 394, representing the number of linked claims (possibly 0) for the best contract for each claim.

As illustrated in FIG. 1, the next step in the process is running a partitioning tree model 122 using as the outcome the best contract field, which contains the categorical values assigned in step 120. Partitioning tree models are a class of statistical models that are used to build branching algorithms (“trees”) that classify data for the purpose of statistical predictions. The endpoint of each tree can either be a categorical prediction, or the parameters of a regression model. Examples of partitioning tree models include the rpart and party packages in R. In the preferred embodiment, the analyst should include as predictors the date of service, and any other characteristics of the claim that are available to the analyst and that the analyst suspects might be used by the health plan administrator in the branching algorithm or in the specific contract terms applied to that claim.

As illustrated in FIG. 1, an optional, but useful, step is measuring the performance of the model produced in step 122, and assessing whether it is appropriate for the analyst to repeat, with modifications, some or all of the earlier steps in the process 124. Examples of measures of the performance of the model include the share of claims and the share of allowed amounts that are unlinked, the share of claims and the share of allowed amounts that have a tied best contract, the share of claims and the share of allowed amounts that have a single best contract but with a weak link (as defined above). Other measures of the performance of the model include, among the claims with a best contract identified, the share with the specific best contract correctly predicted by the partitioning tree model. Measures of model performance could include R-squared, mean absolute deviation, and share of claims with the allowed amount predicted precisely correctly (with “precisely” defined by the analyst using bounds for defining precisely equal). The analyst may, based on the results of step 124, determine that it is necessary and appropriate to return to step 112 and later steps and perform the analysis again using a different set of contract types, or applying different procedures for splitting, cleaning, and aggregating the claims data.

The last step in the process, illustrated in FIG. 1 as step 126, is to take the output of the partitioning tree model, illustrated in FIG. 2 as item 236, and use that output as the summary of the deduced contract for the subset of claims data analyzed. An example of the output of a partitioning tree model is illustrated in FIG. 8.

Accordingly, it is to be understood that the embodiments of the invention herein described are merely illustrative of the application of the principles of the invention. Although the preferred embodiment relates to health care claims and payments for health care services, the process-method could be applied in other contexts in which there is an unknown deterministic branching data generating process. Reference herein to details of the illustrated embodiments is not intended to limit the scope of the claims, which themselves recite those features regarded as essential to the invention.

What is claimed is:

1. A computer-method of using data on paid health care claims to deduce the specific terms of contracts for payment between health plan administrators and health care providers, comprising:
accessing data on paid health care claims;
splitting the claims data into subsets with a separate subset for each combination of health plan administrator, broad type of service, and health care provider;
defining a set of possible contract types where each contract type consists of a set of one or more fields in the claims data and where, for claims paid under that contract type, those fields, in combination with a set of fixed parameters, jointly determine the allowed amount for each claim;
identifying linked claims and linking contracts;
identifying a best contract for each claim; and
running a partitioning tree model for each subset using the best specific contract for each claim as a categorical outcome to be predicted.

2. The computer-method of claim 1, further comprising classification of the specific best contract for each claim into discrete categories that include an “unlinked” category, a “weak link” category, a “tied” category, and a set of categories with one category for each specific best contract not otherwise categorized.

3. The computer-method of claim 1, further comprising the addition of new data elements to the paid claims data where those new data elements are used to define contract types.

4. The computer-method of claim 1, further comprising the application of constraints when identifying linking contracts, where such constraints comprise restrictions on the signs of fixed coefficients to be either strictly positive or strictly negative.

5. The computer-method of claim 1, further comprising the definition of contract types of one, two, three or more dimensions.

6. The computer-method of claim 1, further comprising the splitting of the subsets of data on paid claims into testing and validation subsamples, where one or more testing subsamples is used to identify linking contracts and best contracts and run a partitioning tree model, and one or more validation subsamples is used to test the performance of model.

7. The computer-method of claim 1, further comprising the method of using matrix operations first to test for the linear independence of the matrix X (where X is an N+1×N matrix with N+1 claims on the rows and the N variables that define the contract type on the columns)—if the matrix X is not linearly independent then it cannot be used to identify a linking contract—and then, if X is linearly independent, to identify the existence of a linking contract by testing for the lack of linear independence of Z where Z=[X Y] and where Y is an N+1×1 column vector of allowed amounts.

8. The computer-method of claim 1, further comprising the method of using R-squared to test for linking contracts, where a linking contract is identified if R-squared is near 1.
